(19) United States
(12) Patent Application Publication
(10) Pub. No.: US 2008/0205287 A1
(43) Pub. Date: Aug. 28, 2008

(54) APPARATUS AND METHOD FOR CONTROLLING THE TRANSFER OF COMMUNICATION TRAFFIC TO MULTIPLE LINKS OF A MULTI-LINK SYSTEM

(75) Inventors: Tim Kuhl, Kanata (CA); Andrew Dolganow, Kanata (CA); Christopher Harbin, Kanata (CA)

Correspondence Address: ECKERT SEAMANS CHERIN & MELLOTT, LLC., 600 GRANT STREET, 44TH FLOOR, PITTSBURGH, PA, 15219, US

(73) Assignee: Alcatel Lucent, Paris (FR)

(21) Appl. No.: 11/679,402

(22) Filed: Feb. 27, 2007

(51) Int. Cl. G06F 11/00

(52) U.S. Cl. 370/252

(57) ABSTRACT

An apparatus for controlling the transfer of communication traffic to an interface having a group of links comprises a detector for detecting the sizes of data units to be transferred to the interface, and a controller for causing data units to be transferred to the interface, wherein the controller is operative to select the link to which to transfer a data unit based on the detected size. The group of links includes a reference link that is used as an overflow to receive data units when other member links are full, and when the reference link is not used in its overflow capacity, the controller is operative to bias selection of the links to which to transfer data units towards the other links relative to the reference link.

### FIELD OF THE INVENTION

The present invention relates to apparatus and methods for controlling the transfer of communication traffic to multiple links of a multi-link system, and in particular, but not limited to controlling the transfer of communication traffic in a router or switch onto member links of a multi-link bundle or group.

### BACKGROUND OF THE INVENTION

Network switches or routers may have one or more physical egress ports each having one or more groups or bundles of links for carrying egress communication traffic. Ingress communication packets which are to be routed to the port are received and distributed among the links of the multi-link group for further transmission. To increase transmission speed and reduce latency, particularly for large packets, the router may include a fragmenter which divides packets into smaller packet fragments which are subsequently distributed among different links of the multi-link group, so that the packet is effectively transmitted over two or more links rather than a single link. The fragmented packet is eventually reassembled at an appropriate point in the network. Distribution of packets or packet fragments to the multi-link group is typically managed by a scheduler which initially directs each packet or packet fragment to a particular buffer or queue associated with a particular link of the multi-link group. In one fragmentation scheme, a maximum fragment size is specified and packets larger than the maximum fragment size are divided into one or more fragments of the maximum specified size. Where the size of a packet is not equal to an integral number of maximum size fragments, the last fragment will be smaller than the maximum size. Packets that are smaller than the maximum fragment size are not segmented.

A proposed mechanism for determining which member link to transmit a packet or fragment is based on a determination of the member link with the least depth. This mechanism involves the steps of (1) polling the amount of traffic queued to each member link, (2) transmitting the fragment to the first empty queue found, (3) if no empty queues are found, transmitting the fragment onto the member link with the least amount of queued traffic, and (4) in the event of a tie, selecting one of the tied links, for example, the first tied link to be found or a tied link that is randomly chosen.

One drawback is that this method requires a relatively large amount of information and processing before a link is selected and a packet or packet fragment can be transmitted to the appropriate queue. Another drawback is that it can be difficult to maintain an accurate count of the depth of each member link queue, and this difficulty increases with the number of links in the multi-link group, and with the number of multi-link groups of the system. On highly channelized systems, the amount of processing required may impact throughput on other channels or links of other multi-link groups due to the amount of work required by the algorithm.

Another mechanism for determining the member link to which to transmit a packet or packet fragment involves a round robin selection process between member links and designating one of the member links as a reference link which is selected if another member link is full. This method involves the steps of (1) specifying one of the active links as the reference link. The amount of queued traffic associated with the reference link is monitored and used to back pressure the traffic management device scheduling traffic for the multi-link bundle;

(2) transmitting in a round robin manner successive packets or fragments to each active member link of the multi-link group; and (3) before transmitting to a link, polling the queue status to check if there is sufficient space for the packet or fragment. If there is insufficient space, the fragment is transmitted to the queue of the reference link.

This method requires less computation than the first in selecting the member link to which to transmit a particular packet or fragment. However, this method is not particularly effective in evenly distributing traffic between active member links where packets are divided into multiple fragments and the final fragment is small. In this event, some traffic patterns cause traffic to be unevenly distributed among the member links, causing unexpectedly high delays or poor utilization of the bundle member links. Some member links may become empty while others have large amounts of traffic queued to them.

### SUMMARY OF THE INVENTION

According to one aspect of the present invention, there is provided an apparatus for controlling the transfer of communication traffic to an interface having a plurality of links, comprising a detector for detecting a parameter indicative of the sizes of data units to be transferred to said interface, and a controller operative to cause data units to be transferred to the interface, wherein, for at least one of said links, said controller is operative to select the link to which to transfer a data unit based on the detected parameter of the data unit.

As used herein, the term “data unit” means either a packet or a fragment of a packet whether the fragment is a full fragment or a partial fragment. A “full fragment” is a fragment of a maximum specified fragment size and a “partial fragment” is a fragment of less than the maximum specified fragment size.

In this arrangement, the controller for managing the distribution of data units to the links of a multi-link group is sensitive to the data unit, and this enables the controller to distribute data units to the links more evenly. In particular, the controller is sensitive to a characteristic of the data units that may vary between data units, such as the size of the data unit. This allows the controller to discriminate between differently sized data units and control their distribution to links of a multi-link group on that basis.

When transmitting variable size packet fragments onto a multi-link PPP (point-to-point protocol) or FR (frame relay) interface on a switch or router, the inventors have found that it is desirable to distribute traffic evenly to all member links. The even distribution of traffic minimizes transmission and reassembly latency. On a highly channelized multi-service switch/router, the challenge is to distribute packets evenly to all member links of a bundle without impacting the throughput on other channels. This requires a highly efficient algorithm when selecting a member link onto which to transmit.

In some embodiments, the controller is operative to consecutively select the same link a plurality of times wherein each selection results in the transfer of a data unit to the link, if at least one of the data units has a size below a predetermined value. This mechanism enables, in addition to a relatively small data unit, another data unit to be transferred to the same link before selecting another link, thereby preventing only a relatively small data unit to be transferred to a link in a single transfer session. This results in a more even distribution of traffic between the links of the multi-link group, and reduces the likelihood of a queue or link running dry.

In some embodiments, the apparatus further comprises a detector for detecting another characteristic of a data unit, and the controller is operative to select the link to which to transfer the data unit based on the detected characteristic. Thus, in this embodiment, the controller additionally selects the link based on whether a particular characteristic is present in a data unit. For example, the characteristic may be whether or not the data unit is a fragment of a packet. In one embodiment, if it is determined that the data unit is not a fragment of a packet and is below a predetermined fragment size (and is therefore an integral packet), the controller may be operative only to transfer that packet to the currently selected link without including another data unit which would otherwise increase the amount of traffic transferred to that link in a single transfer session. For example, this mechanism allows full data packets below a predetermined size such as voice packets, for instance, to be distributed among different links rather than two or more packets of such size being transmitted successively on the same link. This also provides a mechanism which allows the controller to discriminate between a full packet below a maximum fragment size and a fragment of a packet below the maximum size so that, for a plurality of consecutive full packets below the maximum fragment size, different member links can be successively selected for the transfer of each packet. This allows a contiguous stream of sub-maximum fragment size packets to be evenly distributed between the links and not all transmitted on a single link, so that the efficiency benefits of the multi-link system can be obtained.

In some embodiments, the plurality of links includes a reference link, and the controller is operative to transfer a data unit initially determined to be transferred to another link to the reference link in response to a status of the other link.

In some embodiments, the other link has an associated queue for receiving data units, and the status is that the queue has insufficient space for receiving the data unit. In this embodiment, the reference link provides an overflow for receiving data units which would otherwise have been transferred to other member links of the multi-link group if their respective queues had sufficient space.

In some embodiments, the controller is operative to select the reference link for the transfer of a data unit other than data units initially determined for transfer to another link. In some embodiments, the controller uses one or more different criteria or one or more different rules for transferring data units to the reference link to that used for transferring data units to another link of the group.

In this arrangement, the reference link is used not only as a data unit overflow but may also be selected by the controller for transmitting data units when not being used for data overflow. The controller may also use a different criteria for transferring data units to the reference link to that used for transferring data to one or more other links. For example, the criteria used by the controller may have the effect that when the reference link is selected for transfer of non-overflow data, less traffic tends to be transferred to the reference link than to at least one other member link. In this arrangement, the controller is operative to bias selection of the links to which to transfer data units, towards one or more other member links relative to the reference link. In one specific, non-limiting example, when a data unit to be transferred to the reference link comprises a partial fragment of a packet (i.e. a fragment below a predetermined maximum fragment size), the controller may transfer only that fragment to the reference link without an additional data unit before selecting the next potential link to which to transfer the next data unit or units. This implementation provides a mechanism for reducing the non-overflow traffic on the reference link relative to traffic on the other member link(s). Thus, in contrast to the conventional round robin distribution mechanism discussed above which tends to under fill member links other than the reference link, the present embodiment better fills the member links while moderating the amount of traffic on the reference link so that better use is made of the multi-link system as a whole.

In some embodiments, a monitor is provided to monitor a status indicative of the amount of traffic and/or the amount of available space in a reference buffer of the reference link and to generate a signal indicative of the status which is used to control the flow of communication traffic to be distributed to the buffers and links of the multi-link group. In some embodiments, only the status signal of the reference buffer is used to control the flow of incoming communication traffic for distribution to the buffers and links of the multi-link group. This arrangement simplifies the system and reduces the resources (e.g. hardware) required to implement this function. In other embodiments, more than one reference link may be provided for a multi-link group, where the number of reference links is less than the total number of member links of the group. In such an arrangement, the status of each, or fewer than each reference buffer may be monitored, and their status used to control the flow of traffic for distribution by the multi-link group.

According to another aspect of the invention, there is provided an apparatus for controlling the transfer of communication traffic to a plurality of links of a group of links, comprising a detector for determining whether each data unit to be transferred to said group of links has a predetermined characteristic, and a controller operative to cause data units to be transferred to said group of links, wherein said controller is operative to select the link of the group to which each data unit is to be transferred, and is operative to control the number of data units transferred to a currently selected link based on the determination.

According to another aspect of the invention, there is provided a method for controlling the transfer of data units to a plurality of links of a group of links, comprising detecting a parameter capable of distinguishing between data units of different size, and selecting a link of the group to which to transfer the data unit based on the detected parameter.

According to another aspect of the present invention, there is provided an apparatus for controlling the transfer of communication traffic to a group of links including a reference link, the apparatus comprising a detector for detecting a status associated with each link and a controller operative to cause data units to be transferred to said reference link in response to the detected status of another link, wherein said controller is operative to select a link for the transfer of each data unit and is operative to transfer more data unit(s) to a link other than said reference link while said other link is selected than to said reference link while said reference link is selected.

In some embodiments, the controller is operative to transfer more data units to one or more links other than the reference link while the respective link is selected based on one or more predetermined criteria.

In some embodiments, the predetermined criteria is that each other link has sufficient space to receive the data unit(s).

In some embodiments, the criteria is based on a characteristic of at least one of the data units to be transferred, for example whether the data unit is less than a predetermined size or is a full packet or fragment of a packet, and/or any other characteristic.

According to another aspect of the invention, there is provided an apparatus for controlling the transfer of communication traffic to one or more buffers, each having an associated link and to a reference buffer having an associated reference link, the apparatus comprising a detector for detecting a characteristic, e.g. the sizes of data units of the communication traffic to be transferred to said buffer(s) and to said reference buffer, and a controller operative to cause data units to be transferred to said buffer(s) and to said reference buffer, wherein said controller is operative in response to the detected characteristic of the data units to bias selection of the buffers to which to transfer data units, towards said plurality of buffers relative to said reference buffer.

In some embodiments, the controller is operative to bias the selection based on one or both of (1) a determination that a buffer other than the reference buffer meets a predetermined criterion, and (2) that a data unit meets a predetermined criterion.

In some embodiments, the predetermined criterion of a buffer is whether the other buffer has sufficient space to receive a data unit. In some embodiments, the predetermined criterion of the data unit is whether the data unit is only part of a data packet.

### BRIEF DESCRIPTION OF THE DRAWINGS

Examples of embodiments of the present invention will now be described with reference to the drawings, in which:

FIG. 1 shows a schematic block diagram of an apparatus according to an embodiment of the present invention;

FIG. 2 shows a flow diagram of an example of a method for controlling the transfer of data units to a multi-link group, according to an embodiment of the invention;

FIG. 3 shows a schematic diagram of the operation of a fragmenter;

FIG. 4A shows a schematic diagram of an operation of a scheduler and buffers of a multi-link system according to an embodiment of the present invention;

FIG. 4B shows a schematic diagram of an operation of a scheduler and buffers of a multi-link system according to an embodiment of the present invention;

FIG. 4C shows a schematic diagram of an operation of a scheduler and buffers of a multi-link system according to an embodiment of the present invention;

FIG. 4D shows a schematic diagram of an operation of a scheduler and buffers of a multi-link system according to an embodiment of the present invention;

FIG. 5A shows a schematic diagram of an operation of a scheduler and buffers of a multi-link system according to an embodiment of the present invention;

FIG. 5B shows a schematic diagram of an operation of a scheduler and buffers of a multi-link system according to an embodiment of the present invention;

FIG. 5C shows a schematic diagram of an operation of a scheduler and buffers of a multi-link system according to an embodiment of the present invention; and

FIG. 5D shows a schematic diagram of an operation of a scheduler and buffers of a multi-link system according to an embodiment of the present invention.

### DESCRIPTION OF EMBODIMENTS

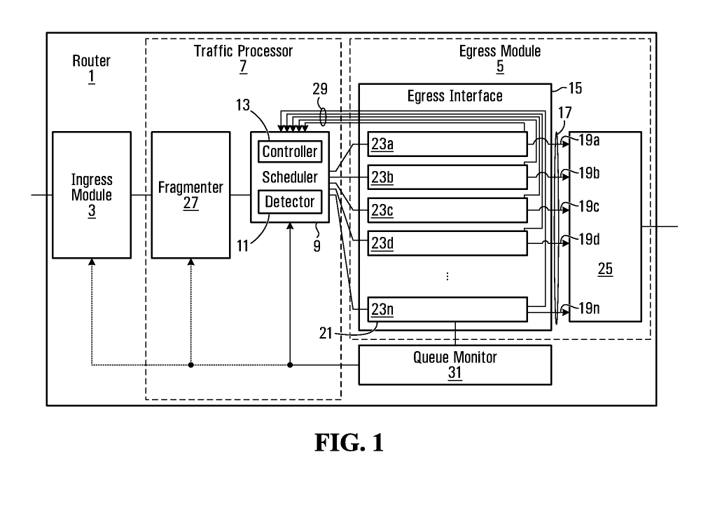

FIG. 1 shows a schematic diagram of a network device, e.g. router or switch incorporating an apparatus according to an embodiment of the present invention. The router 1 comprises an ingress module 3 for receiving communication traffic (e.g. data packets), an egress module 5 for outputting communication traffic and a traffic (or egress) processor module 7 for controlling the transfer of communication traffic from the ingress module 3 to the egress module 5. The apparatus of an embodiment of the invention is incorporated in the traffic processor as a scheduler 9 which includes a detector 11 and a controller 13. The egress module 5 includes an egress interface 15 having a group 17 of links 19a, 19b, 19c, 19d, . . . 19n and a group 21 of buffers 23a, 23b, 23c, 23d, 23n, each associated with a respective link 19a to 19n. The links are connected to a physical port 25. The multi-link group 21 may have any number of links and associated buffers, for example 2, 4, 8, 16, 32, 64, etc., or any other number.

In this embodiment, the router 1 includes a fragmenter 27 operatively coupled to the ingress module 3 for dividing received packets above a predetermined size into packet fragments. The fragmenter may be implemented so that data units output from the fragmenter include full packets which are either equal to or less than the predetermined maximum fragment size, packet fragments of a size equal to the maximum fragment size and partial fragments which are fragments of packets below the maximum fragment size. Thus, data units from the fragmenter may have any size ranging from the maximum fragment size downwards. Data units from the fragmenter 27 are transferred to the egress interface 15 under the control of the scheduler 9. In other embodiments, the fragmenter may be omitted so that, for example, only whole packets are transferred to the multi-link group.

The scheduler 9 comprises a detector 11 for detecting a parameter indicative of the sizes of data units to be transferred to the interface 15. The parameter may be any suitable parameter indicating the size of a data unit, including but not limited to any one or more of (1) the actual size of the data unit, (2) an indication that the data unit is below and/or above a certain size, and (3) an indication that the data unit is within and/or outside a particular size range. The scheduler 9 further comprises a controller which is operative to cause data units to be transferred to the interface 15, wherein, for at least one of the links of the interface, the controller is operative to select the link to which to transfer a data unit based on the parameter of the data unit detected by the detector 11.

In this embodiment, the detector 11 is also operative to detect another characteristic of data units which is also used by the controller 13 to select the link to which to transfer a data unit. The characteristic may be whether the data unit is a full packet which is less than or equal to the maximum fragment size or a partial fragment.

The scheduler including the detector and the controller may be implemented in software, firmware, hardware, or a combination of any two or more of these or by another suitable means.

In this embodiment, one of the links of the group and its associated buffer is functionally designated as a reference link (and reference buffer), which are defined as the link and buffer to which a data unit is transferred by the scheduler if it is determined that another member link to which the data unit would otherwise have been transferred has insufficient space in its associated buffer for receiving the data unit (or the link or buffer status is such that the link/buffer cannot receive the data unit for some other reason). In this particular example, link 19n and its associated buffer 23n are the reference link and reference buffer, respectively, although in other embodiments, any other link and associated buffer may provide the reference link/buffer. In other embodiments, any two or more member links and associated buffers may provide the reference function.

An indicator associated with each buffer 23a to 23n provides an indication to the scheduler 9 indicative of the amount of traffic queued in each buffer, and this is used by the scheduler to determine whether or not a data unit can be transferred to a particular buffer. These indicators are schematically represented in FIG. 1 by the group 29 of lines between the buffers and scheduler 9.

In this embodiment, the router further comprises a queue monitor 31 which monitors the status of the reference buffer 23n. The queue monitor may generate a signal indicative of the available space in the reference buffer for receiving data units and this signal may be used to control (for example, maintain at a current level, increase or decrease) the flow of traffic to be transferred to the buffers and links of the multi-link group. The control signal may be used by any device which is capable of providing such control, which may include but is not limited to any one or more of the scheduler 9, the fragmenter 27, the ingress module 3 or a device upstream of the router or network device 1. Any one or more of these devices may communicate with each other to provide the control.

In the general method of controlling the transfer of data units to member links of a multi-link group which may be implemented by the scheduler 9, for one or more member links, the controller selects the link to which to transfer a data unit based on a parameter indicative of its size. In addition, for these one or more member links, the link to which to transfer a data unit may also be based on another characteristic of a data unit such as whether or not the data unit is a full packet or partial fragment. In one example, where a specific link is selected for the transfer of a partial fragment, the same link may be consecutively selected also for the transfer of another data unit. In this way, the transfer of a relatively small data unit is accompanied by the transfer of another data unit to the same link (or buffer). This makes better use of a transfer session by transferring a larger amount of traffic, assisting in distributing traffic more evenly between the member links and helping to prevent a buffer running out of data units before receiving another unit. However, where a specific link is selected for the transfer of a full packet, only the packet is transferred without an additional data unit, and another buffer/link is initially selected for the transfer of the next data unit. Thus, the controller can discriminate between small packets and small fragments, and distribute small packets evenly among the links of the group.

Although in some embodiments, this method of consecutively selecting the same member link for the transfer of two or more data units before making another selection if one of the data units is a partial fragment may also apply to the reference link, in other embodiments, this method is not applied to the reference link and instead, a different criteria for transferring data to the reference link is used. In one embodiment, the method used for transferring data units to the reference link involves selecting the reference link a number of times which is less than the number of times another member link is consecutively selected to receive data units, and in one specific embodiment, the reference link is selected only once. Thus, in this embodiment, if the reference link is selected to receive a partial fragment, only the partial fragment is transferred to the reference link without a consecutive selection of the reference link for the transfer of another data unit, based on the transfer of a partial fragment. However, the reference link may be selected consecutively for the transfer of two or more data units where the previous transfer was to the reference link and a member link that would have been selected next cannot accept the next data unit and the reference link is invoked in its overflow capacity.

In other embodiments, the controller may be configured to consecutively select a link other than the reference link, for the transfer of n data units, where n≧3 based on a characteristic of a data unit and to consecutively select the reference link for the transfer of n-x data units, where x≧1 based on the same characteristic.

A specific but non-limiting example of an embodiment of a method for controlling the transfer of data units to member links of a multi-link group (or bundle) include the following steps:

(1) One of the active links is specified as the reference link. As mentioned above, the status of the reference link and/or its associated buffer is used to control the flow of traffic to be transferred to the buffers/links of the multi-link bundle, and may for example be used to back pressure the traffic processor, and/or any other device which is capable of controlling the traffic flow.
(2) Member links to which data units are to be transferred are selected in a round-robin manner.
(3) Before transmitting a data unit to a particular link, the status of the associated buffer is pulled to check if the buffer has sufficient space available for the data unit. If there is sufficient space in the selected buffer, the data unit is transferred to the selected buffer. If there is insufficient space, the data unit is transferred to the reference link.
(4) If the data unit to be transferred to a link other than the reference link is a partial fragment (i.e. a fragment of a packet which is smaller than the maximum fragment size), selection is not advanced to the next member link, but the same member link is again selected for receiving the next data unit. Thereafter, selection is advanced to the next member link.
(5) If the data unit to be transferred to the reference link is a partial fragment, the unit is transferred and selection is advanced to the next member link.
(6) If the data unit to be transferred to a member link is a full packet that is equal to or less than the size of a full fragment, the selection advances to the next member link.
(7) If the next data unit to be transferred is a full fragment, the full fragment is transferred to the currently selected link and the selection may advance to the next member link. Alternatively, in another embodiment, if the next two data units to be transferred comprise a full fragment and a partial fragment, the method may be implemented such that both data units are transferred to the same member link.

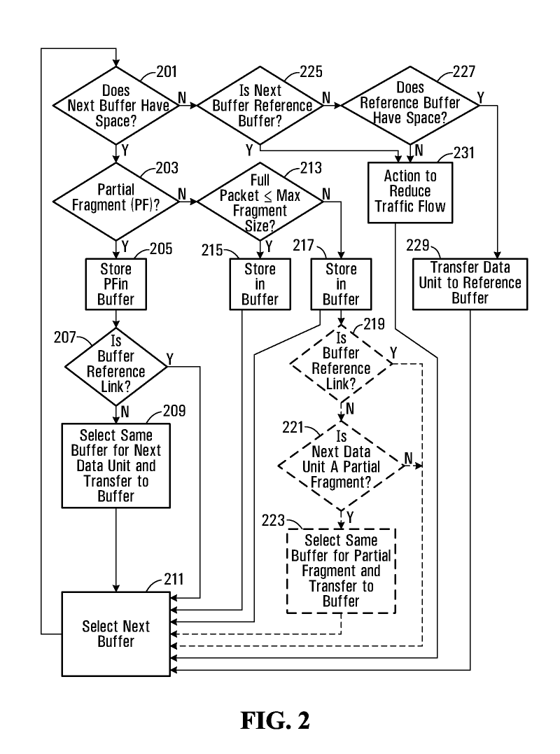

A flow diagram illustrating an example of a process for controlling the transfer of data units to member links of a multi-link group, and which may be implemented by the scheduler 9 shown in FIG. 1, is shown in FIG. 2.

Referring to FIG. 2, at step 201, a determination is made as to whether there is sufficient space in the currently selected member link buffer to receive the next data unit. If there is space, the process advances to step 203, where the process determines whether the next data unit to be transferred to a member link is a partial fragment. If the data unit is a partial fragment, the data unit is transferred to the selected member link buffer at step 205. In any embodiment, the buffer to which a data unit is to be transferred may be indicated by a pointer whose position is controlled by the controller 13 in FIG. 1, for example. At step 207 it is determined whether the buffer in which the partial fragment was stored at step 205 is the reference link buffer, and if not, the process advances to step 209, in which the same buffer is selected for the next data unit, and the next data unit is transferred to the buffer. (In the example given above, the pointer remains pointing at the same buffer for this transfer). Thereafter, the process selects the next member link buffer to which to transfer the next data unit at step 211, which may be implemented by the controller advancing the pointer to the next selected member link buffer. Returning to step 207, if it is determined that the buffer to which the partial fragment was transferred is the reference link buffer, the process advances directly to step 211 (i.e. without the transfer of an additional data unit to the reference link buffer).

Returning to step 203, if it is determined that the data unit is not a partial fragment, it is determined at step 213 whether the data unit is a full packet rather than a fragment. In this case, the full packet may have a size either equal to or less than the maximum fragment size. If the data unit is a packet, the data unit is transferred to the selected member link buffer at step 215 and the process advances to step 211 in which the next member link buffer is selected.

Returning to step 213, if it is determined that the data unit is not a full packet, the process may deduce that the data unit is a full fragment, and transfers the full fragment to the selected member link buffer at step 217. The process may then advance to step 211, in which the next buffer is selected. In an alternative embodiment, after selecting the current member link, e.g. before, during or after transferring the full fragment to the selected buffer at step 217, (or at some other time), the process may perform steps in which a partial fragment is also transferred to the same buffer, an example of which is shown by the broken line steps in FIG. 2. In this example, the process advances from step 217 to step 219 where it is determined whether the selected buffer is that of the reference link. If not, the process advances to step 221 where it is determined whether the next data unit to be transferred is a partial fragment. If the next data unit is a partial fragment, the same buffer is selected and the partial fragment transferred to the buffer at step 223. Thereafter, the process passes to step 211. In this example, the same buffer is effectively consecutively selected for the transfer of both a full and partial fragment. Returning to step 219, if it is determined that the buffer in which the full fragment was stored is the reference link buffer, the process bypasses steps 221 and 223 and advances directly to step 211. Returning to step 221, if it is determined that the next data unit to be transferred is not a partial fragment, the process bypasses step 223 and advances directly to step 211, at which the next buffer is selected.

Embodiments of the process may include both sets of steps 207,209 and steps 219,221 and 223 and in other embodiments, the process may include either one of these two sets of steps but not the other.

Once the next buffer for transfer of the next data unit is selected at step 211, the process determines if the selected buffer has sufficient space to receive the data unit at step 201. If yes, the process advances to step 203 and the cycle is repeated. If, at step 201 it is determined that the selected buffer has insufficient space, it is determined whether the selected buffer is the reference link buffer at step 225 and if not, a determination is made as to whether the reference buffer has sufficient space at step 227. If the reference buffer has sufficient space, the data unit is transferred to the reference buffer at step 229 and the process then advances to step 211 at which the next buffer is selected. Returning to step 227, if it is determined that the reference buffer does not have sufficient space, action is taken to reduce traffic flow for distribution to the member link group. Similarly, if at step 225 it is determined that the selected buffer that has insufficient space (as determined at step 201) is the reference buffer, the process advances to step 231 at which appropriate action is taken. Once appropriate action has been taken or while appropriate action is being taken, the process may again advance to step 211 at which the next member link buffer to which a data unit is to be transferred is selected.

The flow diagram of FIG. 2 merely illustrates an example of a process for controlling the transfer of data units to a member link group. Any one or more of the particular process steps illustrated may be changed or omitted, as appropriate, and/or the ordering of the steps of the process may be changed, as appropriate. For example, step 203 and its related steps 205,207,209 may change position with step 213 and its related step 215. Steps 203 and 213 may be performed by the detector 11 of the scheduler of the embodiment of FIG. 1.

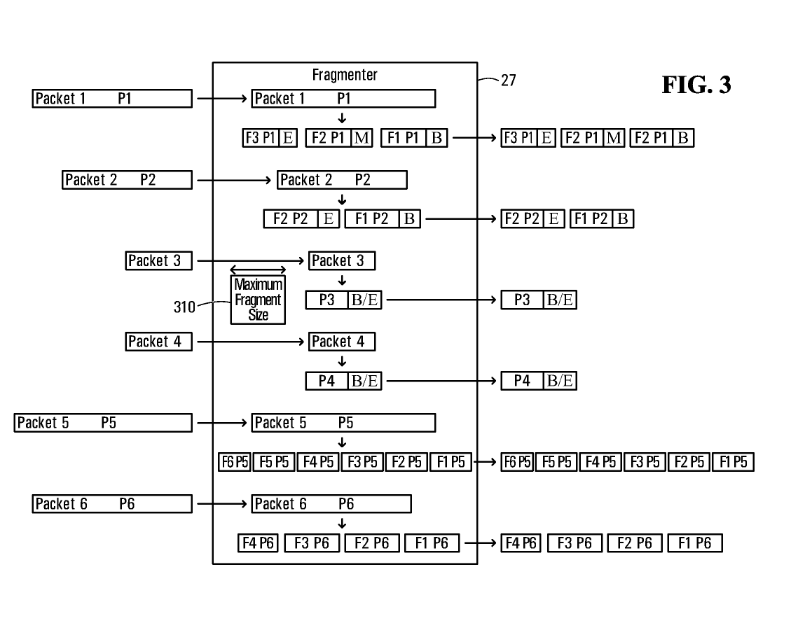

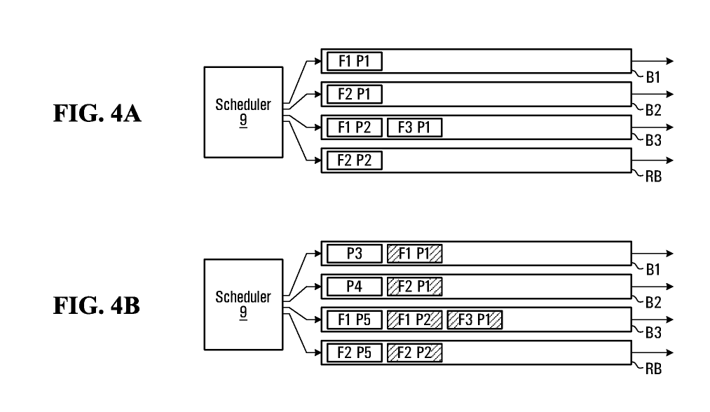

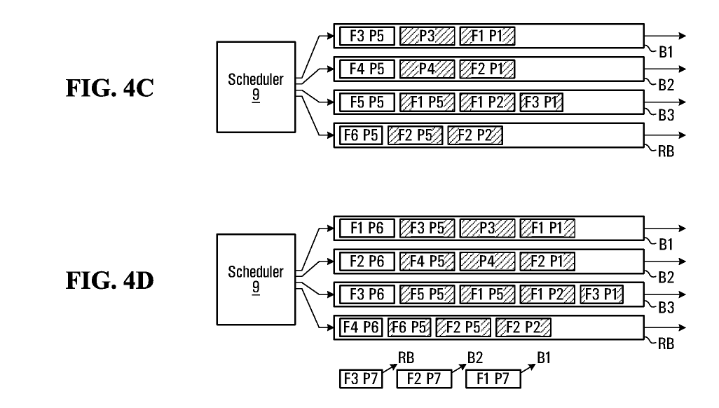

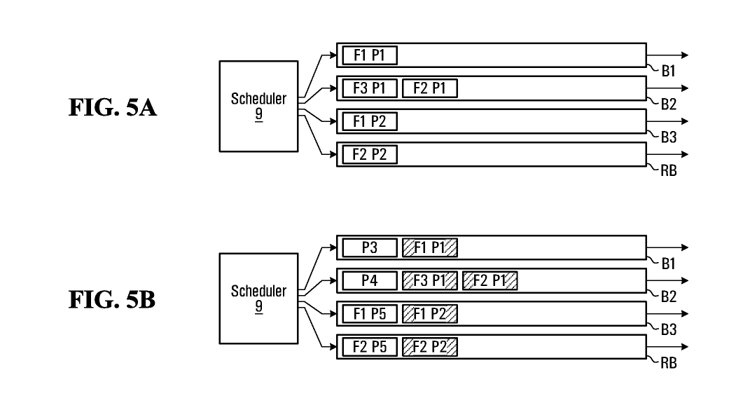

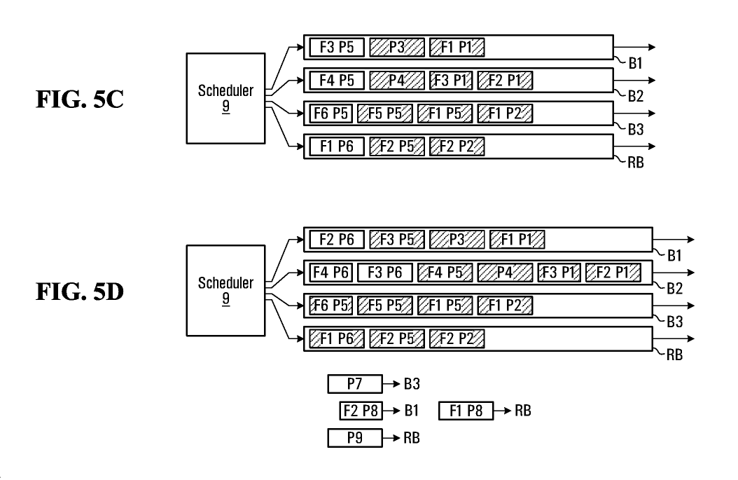

A more specific but merely illustrative and non-limiting example of an implementation of a process for transferring data units to member links of a multi-link group based on the embodiment of the method shown in FIG. 2 and which may be implemented using the embodiment of the apparatus shown in FIG. 1 will now be described with reference to FIG. 3, FIGS. 4A to 4D and FIGS. 5A to 5D. FIG. 3 shows an example of the operation on a number of exemplary packets by the fragmenter 27, FIGS. 4A to 4D show a first example of the operation of the scheduler 9 in distributing the packets to member links of a multi-link group and FIGS. 5A to 5D show another example of the operation of the scheduler 9 transferring the packets received from the fragmenter 27 to the member links of a group.

Referring to FIG. 3, the fragmenter 27 is configured to receive packets and to fragment packets only above a predetermined maximum fragment size 310 into packet fragments. The fragmenter may be implemented so that each packet fragment is equal to the maximum fragment size, unless the packet is not an integral multiple of the maximum fragment size, in which case, one of the packet fragments will (typically the last, although it could be some other fragment of the packet) be less than the maximum fragment size, i.e. a partial fragment. The maximum fragment size may be specified as any suitable value, for example 128 bytes, or any other value. The maximum fragment size may be selected depending on such factors as the type or types of communication traffic to be received by and/or output from the router or other device, the processing capacity and/or the number of member links in a multi-link group and/or any other factor(s).

As illustrated in FIG. 3, the fragmenter receives and processes a number of different packets P1 to P6 and outputs each packet as a number of packet fragments or a full packet, as appropriate. For ease of illustration, the processes performed on the packets by the fragmenter are shown together and this does not imply any particular timing for each process relative to another. Packets may be received by the fragmenter in series one after the other or in parallel. In one embodiment, the fragmenter processes each received packet in series (although in other embodiments, the fragmenter may process packets in parallel). Packets may be output by the fragmenter in series or in parallel. In the latter case, packets may be output in parallel where there are no packet order issues. For example, in some systems, fragmentation and reassembly is performed in order on a per-packet basis and reassembly cannot be performed on interleaved fragments of different packets. However, parallel fragmentation and reassembly may be implemented in other systems, and fragments may be tagged with a fragment/packet identifier to identify both the fragment and the packet to which it belongs vis-à-vis fragments of other packets. For example, this may be useful for multiclass MLPPP, where a fragmentation reassembly identifier is added to the fragment/packet.

In the example of FIG. 3, the fragmenter divides the first packet P1 into two full fragments F1P1, F2P1 and a partial fragment F3P1. Where packets are fragmented, the fragmenter labels each fragment to enable the fragments to be reassembled into the packet in the correct order. In this example, the first packet is labeled “B” (“Beginning”), the second packet is labeled “M” (“Middle”) and the last packet is labeled “E” (“End”). If there is more than one “middle” fragment, middle fragments may be labeled appropriately so that their ordering can be reproduced, an example of which is “M1”, “M2”, “M3”, etc. The second packet P2 has a size of twice that of the maximum fragment size and is divided by the fragmenter into two full fragments F1P2, F2P2. Packets P3 and P4 are both less than the maximum fragment size, and are therefore not fragmented. For such packets, the fragmenter may be arranged to label the packet to indicate that it is a full packet of either less than or equal to the maximum fragment size, and in this example, the packet is labeled “B/E” (or other suitable label) indicating that the data unit includes both the “beginning” and the “end” of a packet and is therefore a full packet. Packet P5 has a length between five and six times the maximum fragment size and is therefore divided into five full fragments F1P5 to F5P5 and a partial fragment F6P5. Packet P6 has a size between three and four times the maximum fragment size and is therefore divided into three full fragments F1P6 to F3P6 and a partial fragment F4P6.

In this example, the fragmented packets or full packets from the fragmenter 27 are made available for distribution to the member links of the multi-link group in the order of P1 to P6 and the fragments of each packet are made available in the same order in which they appear in the packet. (In other embodiments, packets and/or fragments of a packet may be made available for distribution in any other order.)

FIGS. 4A to 4D illustrate four consecutive data unit distribution cycles to the multi-link group which are implemented by the scheduler 9. In this example, the multi-link group comprises four buffers B1, B2, B3, RB where buffer RB functions as the reference buffer (although any other buffer may provide this function). In this example, the cycle is implemented generally as a round robin distribution cycle. In the first cycle shown in FIG. 4A, the first two fragments of the first packet F1P1, F2P2 are transferred respectively to the first and second buffers B1, B2 and the third, partial fragment of the first packet F3P1 is transferred to the third buffer B3. Invoking the process rules 207 and 209 illustrated in FIG. 2, the third buffer is also selected to receive the next data unit and therefore the first full fragment of the second packet F1P2 is also transferred to the third buffer B3. The scheduler then selects the reference buffer RB for the next transfer and the second full fragment F2P2 of the second packet is transferred to the reference buffer.

In the next cycle shown in FIG. 4B, the scheduler selects the first buffer B1 for the next transfer and transfers packet P3 to buffer B1. As packet P3 is a full packet having a size equal to or less than the maximum fragment size and invoking process rules 213, 215 and 211 of FIG. 2, selection of the buffer for the transfer of the next data unit advances to the next buffer, which in this case is B2. The fourth packet P4 is transferred to the second buffer. Again, as P4 is a full packet (i.e. having a size equal to or less than the maximum fragment size), buffer selection for the next transfer advances to the next buffer, which is B3. The next data unit which is F1P5 is transferred to the third buffer and selection advances to the reference buffer for the transfer of the next data unit which is F2P5. To facilitate visualizing which packets are transferred in each cycle, the data units transferred to the buffers in the previous cycle(s) are hatched, while those transferred in the present cycle are not.

In the third cycle illustrated in FIG. 4C, the next full fragments F3P5, F4P5 and F5P5 of the fifth packet are respectively transferred to the first, second and third buffers B1, B2 and B3, and the last data unit of the fifth packet, which is a partial fragment is transferred to the reference buffer RB.

In the next cycle, illustrated in FIG. 4D, and invoking the process rule 207 illustrated in FIG. 2, as the partial fragment F6P5 of the fifth packet was transferred to the reference buffer, the buffer selection for the next transfer advances to the next buffer, which in this case is buffer B1. The three full fragments of the sixth packet, F1P6, F2P6 and F3P6 are respectively transferred to the first, second and third buffers B1, B2 and B3 and the last fragment of the sixth packet F4P6 which is a partial fragment is transferred to the reference buffer RB. In the next cycle, as a partial fragment was transferred to the reference buffer, buffer selection for the next transfer advances to the next buffer, e.g. B1.

FIG. 4D shows three further data units for transfer to the link buffers, F1P7 and F2P7 which are both full fragments of a packet P7, and F3P7 which is a partial fragment of packet P7. In the next cycle, fragments F1P7 and F2P7 are transferred to buffers B1 and B2, respectively, and B3 is then selected as the candidate buffer for the transfer of partial fragment F3P7. However, in this example, and for illustrative purposes only, if buffer B3 does not have sufficient space for the partial fragment, as shown in FIG. 4D, for example, because its associated link is at its flow rate capacity, is congested or for some other reason, the reference buffer RB is selected for the transfer, and the partial fragment is transferred to the reference buffer.

It can be appreciated from the above example, that the distribution method tends to cause the non-reference link member buffers to receive a higher proportion of the available data units for distribution to the group per distribution cycle compared to the prior methods. In the embodiment, this is achieved by consecutively selecting the same buffer for the transfer of two data (or possible more) units, where one of the data units is relatively small. This helps to ensure that each time a buffer is selected in the distribution cycle, a larger minimum amount of traffic is transferred to that buffer before advancing to the next buffer, making it less likely that that partial buffer runs out of data units to transfer to the link before it is selected again in the next distribution cycle. Advantageously, this also helps to reduce or eliminate latency in reassembling fragments due to delays in receiving one or more packet fragments.

Referring to an alternative (or additional) process illustrated in FIGS. 5A to 5D, in the first cycle illustrated in FIG. 5A, the first and second full fragments of the first packet, FlP1, F2P1 are transferred to the first and second buffers, B1, B2, respectively. Invoking process rules 219, 221 and 223 of FIG. 2, as the next data unit to be transferred is a partial fragment and the current buffer is not the reference buffer, the same buffer, B2, is also selected for the transfer of the next data unit F3P1. Each of the full fragments F1P2, F2P2 of the second packet are transferred to the third and reference buffers, respectively. In the second cycle illustrated in FIG. 5B, each of full packets P3 and P4 are transferred, respectively, to the first and second buffers B1, B2, in accordance with process rules 213, 215 and 211 of FIG. 2. The first and second full fragments F1P5, F2P5 of the fifth packet are transferred, respectively, to the third and reference buffers B3, RB.

In the third cycle shown in FIG. 5C, the third, fourth and fifth full fragments of the fifth packet are respectively transferred to the first, second and third buffers B1, B2, B3. As the next data unit to be transferred, F6P5 is a partial fragment and the current selected buffer is not a reference buffer, the current buffer is also selected for the transfer of the partial fragment F6P5. Buffer selection then advances to the next buffer, which in this case is the reference buffer for the transfer of the next data unit, F1P6.

In the next cycle illustrated in FIG. 5D, the second and third full fragments of the sixth packet F2P6, F3P6 are respectively transferred to the first and second buffers B1, B2. As the next data unit F4P6 to be transferred is a partial fragment, the current buffer, B2, is also selected for the transfer of the partial fragment F4P6.

For illustrative purposes, further data units to be transferred to the member links of the multi-link group may include data units P7, F1P8, F2P8 and P9. After the partial fragment F4P6 is transferred to the buffer B2 together with the full fragment F3P6, buffer selection advances to the next buffer, B3, for the transfer of the next data unit P7. As data unit P7 is a full packet, buffer selection then advances to the next buffer which is the reference buffer RB, and the next data unit which is a full fragment F1P8 is transferred thereto. Invoking the process rule 219 illustrated in FIG. 2, as the next data unit is a partial fragment F2P8 but the current buffer is the reference buffer, buffer selection advances to the next buffer, which in this case is B1, and the partial fragment F2P8 is transferred thereto. In accordance with step 223, buffer selection then advances to the next buffer B2 for the transfer of the next data unit, P9. For illustrative purposes only, if there is congestion or some other problem on the link of buffer B2, or the data flow on the link is at its maximum limit, buffer B2 may become full and cannot accept another data unit. In this case, it is determined that there is sufficient room in the reference buffer, and data unit P9 is transferred to the reference buffer in accordance with process steps 227 and 229 of FIG. 2.

It will be appreciated that this method is similar to that and provides the same benefits as the method described above with reference to FIGS. 2 and 4A to 4D.

Other benefits provided by embodiments of the method are that as the distribution method helps to more evenly distribute data units among the links of a multi-link group so that the link buffers are less likely to run dry or become full and unable to accept a data unit when selected, the buffer size may be reduced and/or the number of member links may be increased without compromising performance due to these two effects. The number of member links can be increased as it is less likely that the link buffer will run dry before it is next selected. The buffer size can be maintained or reduced as it is not necessary to oversize the buffers, if the number of buffers is increased, in order to accommodate more data units in each buffer to reduce the likelihood of running dry due to the increased time to complete a distribution cycle. Distributing the data units more evenly may also reduce the number of times the reference link is involved in its overflow capacity, which also reduces the additional processing involved, thereby making the distribution method even more efficient.

Embodiments of the apparatus and method may be applied to any device requiring data distribution over a plurality of links, including, but not limited to network devices including switches and routers, examples of which include Multi-link Point to Point Protocol (ML PPP), Multi-Link Frame Relay (MLFR) as well as others, relays, end user devices, e.g. computers, mobile or static communication devices including personal handheld devices, including mobile telephones and other devices. Embodiments of the apparatus and method may be used in any communication network including wireless, or landline including wireline, optical and/or any other communication traffic conveying media.

It is to be noted that a round robin buffer selection cycle may start with any buffer and the buffer may be selected in any predetermined sequence.

In any aspect or embodiment of the apparatus or method described herein, any one or more features may be omitted altogether or substituted by one or more other features, which may or may not be an equivalent thereof.

Other aspects and embodiments comprise any one or more features disclosed herein in combination with any one or more other features disclosed herein, or a variant or equivalent thereof.

Numerous modifications to the embodiments described herein will be apparent to those skilled in the art.

1. An apparatus for controlling the transfer of communication traffic to an interface having a plurality of links, comprising a detector for detecting a parameter indicative of the sizes of data units to be transferred to said interface, and a controller operative to cause data units to be transferred to the interface, wherein, for at least one of said links, said controller is operative to select the link to which to transfer a data unit based on the detected parameter of the data unit.

2. An apparatus as claimed in claim 1, wherein said controller is operative to select the same link for the transfer of a plurality of consecutive data units, if at least one of said data units has a size below a predetermined value.

3. An apparatus as claimed in claim 2, further comprising a detector for detecting another characteristic of a data unit, and wherein said controller is operative to select the link to which to transfer said data unit based on said detected characteristic.

4. An apparatus as claimed in claim 3, wherein said characteristic is whether said data unit is a fragment of a packet.

5. An apparatus as claimed in claim 4, wherein said controller is operative only to select the same link for the transfer of a plurality of consecutive data units if at least one of said data units has a size below a predetermined fragment size and is a fragment of a packet.

6. An apparatus as claimed in claim 5, wherein said plurality of links includes a reference link, and said controller is operative to transfer a data unit initially determined to be transferred to another link to said reference link based on a status of said other link.

7. An apparatus as claimed in claim 6, wherein said other link has an associated buffer for receiving data units, and said status is that said buffer has insufficient space for receiving a data unit.

8. An apparatus as claimed in claim 6, wherein said controller is operative to select said reference link for the transfer of a data unit other than data units initially determined for transfer to another link, and said controller uses a different criteria for transferring said other data units to said reference link to that used for transferring data units to another link.

9. An apparatus as claimed in claim 8, wherein said different criteria includes transferring fewer data units to said reference link when said reference link is selected to receive said other data unit, than said plurality of data units that are transferred to another link when at least one of said data units transferred to said other link has a size below said predetermined value.

10. An apparatus as claimed in claim 9, wherein said fewer data units comprises a single data unit.

11. An apparatus as claimed in claim 6, wherein said reference link has an associated reference buffer, and said apparatus further comprises a monitor for monitoring the status of said reference buffer and for generating a signal indicative of the status of said reference buffer.

12. An apparatus as claimed in claim 11, operatively coupled to a functional element capable of controlling the flow of communication traffic to be distributed by said controller, said functional element being operative to control said flow in response to said signal.

13. An apparatus as claimed in claim 12, wherein said functional element is operative to control said traffic flow to be distributed by said controller in response to the status of a number of one or more links of the interface, wherein the number is less than the number of links.

14. An apparatus as claimed in claim 1, wherein each of said plurality of links is a member of a multi-link group, all of which are coupled to the same port of a communication device.

15. An apparatus as claimed in claim 1, operatively coupled to a fragmenter for receiving and dividing packets into two or more fragments, and for providing the fragments as data units for distribution to said links by said controller.

16. An apparatus for controlling the transfer of communication traffic to a plurality of links of a group of links, comprising a detector for determining whether each data unit to be transferred to said group of links has a predetermined characteristic, and a controller operative to cause data units to be transferred to said group of links, wherein said controller is operative to select the link of the group to which each data unit is to be transferred, and is operative to control the number of data units transferred to a currently selected link based on the determination.

17. An apparatus as claimed in claim 16, wherein said characteristic is indicative of the size of the data unit.

18. An apparatus as claimed in claim 17, wherein said controller is operative to transfer two or more data units to the currently selected link, if the size of at least one of the data units is below a predetermined value.

19. A method for controlling the transfer of data units to a plurality of links of a group of links, comprising detecting a parameter capable of distinguishing between data units of different size, and selecting a link of the group to which to transfer the data unit based on the detected parameter.

20. A method as claimed in claim 19, comprising selecting a link for the transfer of one or more data units, detecting said parameter for at least one of a plurality of data units, and if the detected parameter of at least one of said plurality of data units indicates that the data unit(s) has a size below a predetermined value, transferring one of said data units to the selected link, consecutively selecting the same link for the transfer of another of said plurality of data units, and transferring said other data unit to the same link, wherein at least one of said data units transferred to said selected link has a size below said predetermined value.

21. An apparatus for controlling the transfer of communication traffic to a group of links including a reference link, the apparatus comprising a detector for detecting a status associated with each link and a controller operative to cause data units to be transferred to said reference link in response to the detected status of another link, wherein said controller is operative to select a link for the transfer of each data unit and is operative to transfer more data unit(s) to a link other than said reference link while said other link is selected than to said reference link while said reference link is selected.

22. An apparatus as claimed in claim 21, wherein said controller is operative to transfer more data units to one or more links other than said reference link while the respective link is selected based on one or more predetermined criteria.

23. An apparatus as claimed in claim 22, wherein at least one of (1) said criteria is that each other link has sufficient space to receive the data unit(s) and (2) said criteria is based on a characteristic of at least one of the data units to be transferred.

24. An apparatus as claimed in claim 23, wherein said characteristic is one or more of (1) size of a data unit and (2) whether said data unit is a full packet or a fragment of a packet.
